(19) United States
(12) Patent Application Publication
(10) Pub. No.: US 2008/0281876 A1
(43) Pub. Date: Nov. 13, 2008

(54) METHODS AND APPARATUS TO RECOVER DATA AND CONFIGURATION OF STORAGE SYSTEM

(75) Inventor: Yasuyuki MIMATSU, Cupertino, CA (US)

Correspondence Address: SUGHRUE MION, PLLC, 2100 Pennsylvania Avenue, N.W., Washington, DC, 20037, US

(73) Assignee: HITACHI, LTD., Tokyo (JP)

(21) Appl. No.: 11/747,126

(22) Filed: May 10, 2007

(51) Int. Cl. G06F 12/00

(52) U.S. Cl. 707/202; 707/E17.007

(57) ABSTRACT

Every configuration change and/or detected failure is stored in the CDP journal together with time point information indicative of the time when the respective change or the failure has occurred. When the administrator performs the recovery of the data by specifying the recovery time point, the content of journal is displayed to the administrator so that the administrator can search for a recovery point by referring not only to series of data changes but also the series of events. If the administrator specifies a recovery point and initiates the recovery process, the configuration at the recovery time point is reproduced by undoing configuration changes between the current time point and the recovery time point.

### FIELD OF THE INVENTION

This invention generally relates to data recovery, and, more specifically, to techniques for assisting storage system administrator in finding appropriate recovery points and recovering the configuration of the storage system at a specified time point in addition to data recovery.

### DESCRIPTION OF THE RELATED ART

Recently, advanced disk storage systems began to enable a function called Continuous Data Protection (CDP), which continuously records every change made to the stored data as well as the time point information indicative of the time when the change occurs. The area which contains the aforesaid recorded information is called journal. When the stored data is lost due to an equipment failure or accidental/erroneous operation, CDP can recover the lost data by accessing the past data changes recorded in the journal and using the journal to undo those changes. Administrator of the storage system can specify any time point recorded in the journal as a recovery time point.

Conventional CDP technology is described, for example, in published U.S. patent application No. US20040268067 A1 by Yamagami, entitled “Method and apparatus for backup and recovery system using storage based journaling”, which is incorporated herein by reference in its entirety.

However, certain problems with the existing CDP technology remain. First, it is difficult for administrator to search appropriate recovery point by referring to series of time points only. Also, there can be configuration changes between the recovery point and current time point. For example, if a Logical Unit Number (LUN) assigned to LU to be recovered at a FC port is deleted, it is impossible to access the recovered data from a client computer even if the data is recovered. To make the data accessible, the configuration of the storage system at the recovery point needs to be also reproduced.

Thus, the existing technology fails to provide a method and apparatus which records failures and configuration changes in CDP journal such that the administrator can search recovery time point by referring to series of events and reproduce not only the data but also the system configuration at the recovery time point.

### SUMMARY OF THE INVENTION

The inventive methodology is directed to methods and systems that substantially obviate one or more of the above and other problems associated with conventional techniques for continuous data protection.

In accordance with one aspect of the inventive methodology, every configuration change and/or detected failure is stored in the CDP journal together with time point information indicative of the time when the respective change or the failure has occurred. When the administrator performs the recovery of the data by specifying the recovery time point, the content of journal is displayed to the administrator so that the administrator can search for a recovery point by referring not only to series of data changes but also the series of events. If the administrator specifies a recovery point and initiates the recovery process, the configuration at the recovery time point is reproduced by undoing configuration changes between the current time point and the recovery time point.

In accordance with one aspect of the inventive concept, there is provided is a computerized data storage system. The inventive system includes a storage module configured to store data; a control module configured to modify the stored data according to a request from at least one client computer; and a continuous data protection module configured to store information on modification to the stored data in a journal. The continuous data protection module is additionally configures to store to the journal information on configuration changes associated with the computerized data storage system and time information associated with the configuration changes.

In accordance with another embodiment of the inventive concept, there is provided a computerized data storage system. The inventive storage system includes a storage module configured to store data; a controller module configured to modify the stored data according to a request from at least one client computer; and a continuous data protection module configured to store information on modification to the stored data in a journal. The continuous data protection module is further configured to store to the journal information on detected failures associated with the computerized data storage system and time information associated with the detected failures.

In accordance with yet another embodiment of the inventive concept, there is provided a method to be performed by a computerized data storage system. The inventive method involves storing data in a storage device; receiving a data modification request from a client computer; modifying the stored data according to the received data modification request; storing information on modification to the stored data in a journal; and storing to the journal information on configuration changes associated with the computerized data storage system and time information associated with the configuration changes.

In accordance with further embodiment of the inventive concept, there is provided a method to be performed by a computerized data storage system. The inventive method involves storing data on a storage media; receiving a data modification request from a client computer; modifying the stored data according to the received data modification request; storing information on modification to the stored data in a journal; detecting failures associated with the computerized data storage system; and storing to the journal information on the detected failures associated with the computerized data storage system.

In accordance with yet further embodiment of the inventive concept, there is provided a journal including information on modification to data stored in a computerized data storage system; and information on configuration changes associated with the computerized data storage system and time information associated with the configuration changes.

In accordance with yet further embodiment of the inventive concept, there is provided a journal including information on modification to data stored in a computerized data storage system; and information on detected failures associated with the computerized data storage system and time information associated with the detected failures.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows an overview of a computer storage system in which the method and apparatus of this invention is applied.

FIG. 2 illustrates an exemplary embodiment of a drive table.

FIG. 3 illustrates an exemplary embodiment of an LU table.

FIG. 4 illustrates an exemplary embodiment of an LUN table.

FIG. 5 illustrates an exemplary embodiment of journal records.

FIG. 6 illustrates a list of various operations performed by storage system together with corresponding recovery operations to be recorded in CDP journal.

FIG. 7 illustrates the control flow of storage system control program operable to process READ and WRITE commands.

FIGS. 8A and 8B show the process flow for processing of management commands other than the recovery commands.

FIG. 9 illustrates the process flow of the inventive recovery procedure.

FIG. 10 illustrates an exemplary embodiment of a block pool table.

FIG. 11 illustrates an exemplary embodiment of a virtual logical unit (VLU) table.

FIG. 12 shows a list of additional operations and corresponding recovery operations to be recorded in CDP journal.

FIG. 13 illustrates the control flow of another exemplary embodiment of a storage system control program operable to process READ and WRITE commands.

FIGS. 14A and 14B show another exemplary embodiment of process flow for processing of management commands other than the recovery commands.

FIG. 15 illustrates an exemplary embodiment of a computer platform upon which the inventive system may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

### First Embodiment

### 1. System Configuration

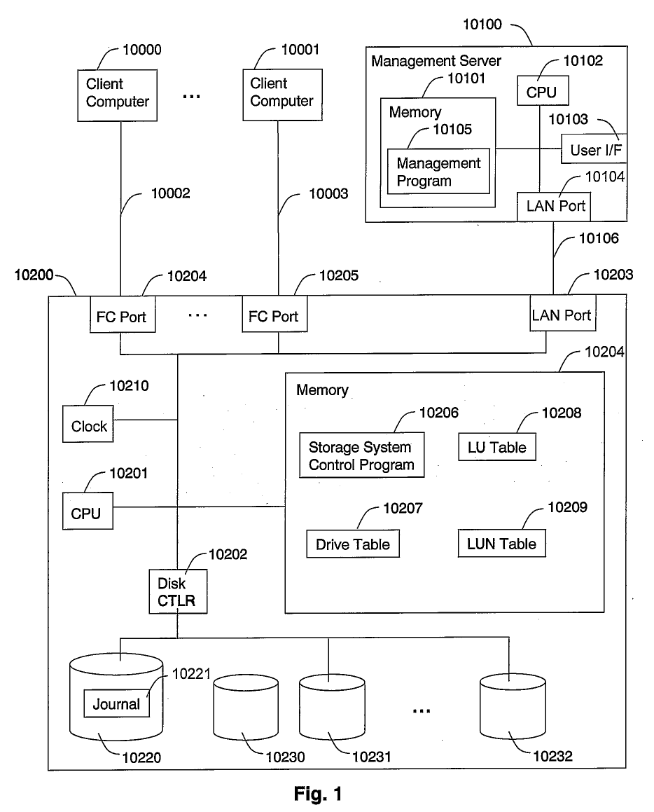

FIG. 1 shows an overview of a computer storage system in which the method and apparatus of this invention is applied.

(1) Client computers 10000-10001 are connected to a disk array system 10200 via Fibre Channel (FC) cables 10002 and 10003. Client computers access data stored in the disk array system by issuing READ or WRITE commands which specify LUN assigned at the FC port in the storage system and Logical Block Address (LBA) of the data to be accessed. Each FC port in the disk array is identified by port ID. In this embodiment, it is assumed for simplicity that the READ or WRITE command accesses one block at a time. However, it is possible to access multiple blocks by including the data size information into the data access command.

(2) The storage system is managed by an administrator from a management server 10100. The management server 10100 includes a CPU 10102, which executes Management Program 10105 stored in its memory 10101. The management program 10105 communicates with the administrator through a user interface 10103 and also communicates with the disk array system through a LAN port 10104. LAN port 10104 is connected to the disk array system via the LAN cable 10106.

(3) Disk array system 10200 includes FC ports 10204 and 10205 provided to enable communication with the client computers. The disk array system also has LAN port 10203 provided to enable communication with the management server. The disk array system 10200 also has a disk drive 10220, which stores CDP journal. In addition, the disk array system 10200 includes disk drives 10230-10232 provided to store data. These disk drives are controlled by the disk controller 10202.

(4) The CPU 10201 executes Storage System Control Program 10206, which is stored in memory 20204. Specifically, the Storage System Control Program processes READ and WRITE commands received from the clients. The Storage System Control Program 10206 also communicates with the management console and processes management requests to change the configuration of the disk array system. During the execution of the input/output (I/O) operations or the management process, the Storage System Control Program 10206 reads and writes CDP journal. The time information to be stored in the journal is provided by the Clock 10210.

(5) The memory 10204 stores a drive table, which is used in managing disk drives in the disk array system, LU table, which defines LUs, and LUN table, which defines mapping between LUs and ports.

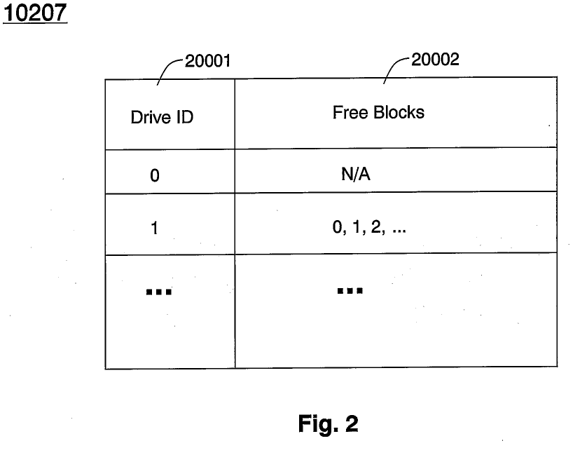

(A) As shown in FIG. 2, for each disk drive, drive table 10207 contains drive ID 20001 and information on free blocks 20002, which contains a list of logical block address (LBA), which is not used to compose any LU. Entry N/A means that all blocks are used.

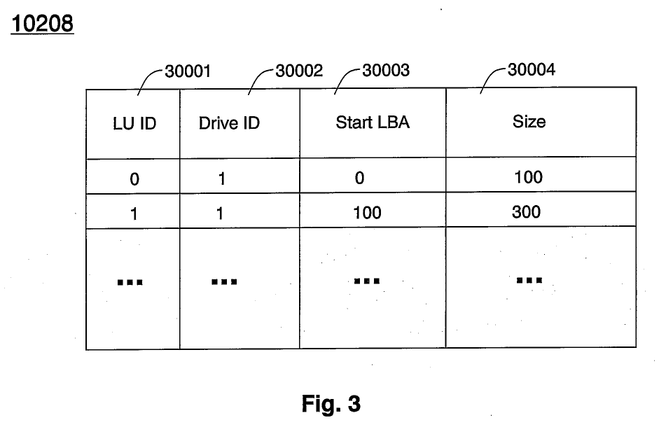

(B) As shown in FIG. 3, for each created LU, the LU table 10208 contains LU ID 3001, ID of disk drive 30002, which hosts the LU, start LBA of the LU within the drive 30003, and the size of the LU 30004. For simplicity, in this embodiment, LU is considered to be a partition of a disk drive. However, it is possible to implement LU as a logical unit consisting of multiple disk drives by using RAID (redundant array of inexpensive disks) technology, well known to persons of skill in the art.

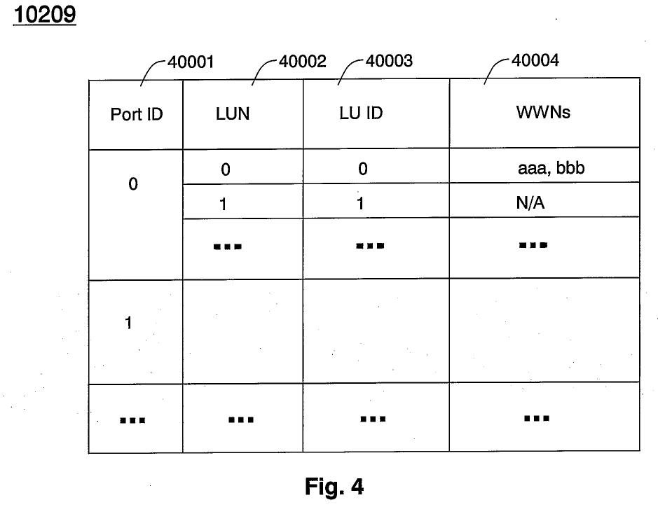

(C) As shown in FIG. 4, for each LUN 40002 of each port 40001, LUN table 10209 contains ID of LU 40003 which is assigned the LUN at the port and a list of World Wide Names (WWNs) 40004 of client computers which are allowed to access the specific LUN.

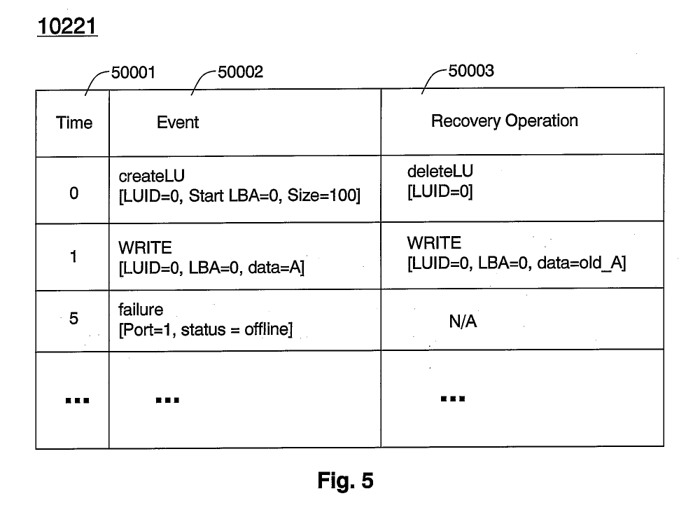

(6) A disk drive 10220 stores CDP journal 10221. In this embodiment, for purposes of simplicity, it is assumed that the journal is stored in a single disk drive. However, it is possible to store the journal in a logical unit, which consists of multiple disk drives. As shown in FIG. 5, for each recorded event, the CDP journal 10221 contains the time point of the event 50001, the event information 50002 including the information on the type of operation or event and the associated arguments or parameters, and a recovery operation 50003 which is an operation, together with the associated arguments, operable to undo the operation recorded in the aforesaid record 50002. If the event type is a failure, the value “N/A” is recorded as the recovery operation.

### 2. Operations and Recovery Operations

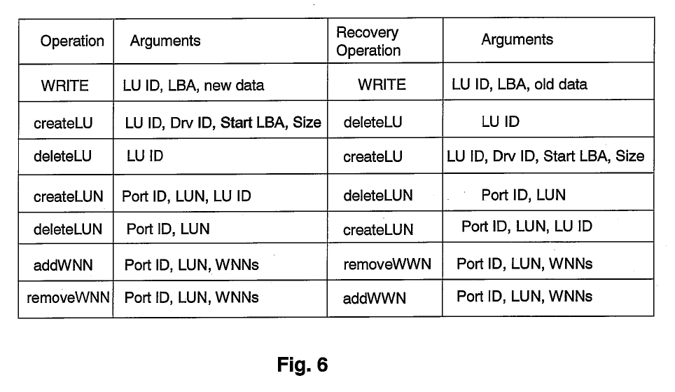

FIG. 6 illustrates a list of various operations performed by the storage system together with the corresponding recovery operations to be recorded in the CDP journal in this embodiment. For example, the WRITE operation is issued by client computers to update data. Other operations are issued by the management server to change configuration of the disk array system. These operations update tables by adding new entries, deleting existing entries, or modifying the contents of tables based on the arguments described below.

The WRITE command is issued to a FC port of the disk array and incorporates information on LUN, LBA and the subject data. LU to be accessed is identified by referring to the LUN table and looking up the LU ID corresponding to the port and specified LUN. The recovery operation corresponding to this operation is WRITE operation with the old data.

createLU operation creates an LU by specifying LU ID of the new LU, ID of a disk drive which will contain the LU, start LBA of the LU in the disk drive, and size of the LU. Recovery operation associated with this operation is deleteLU, which specifies the LU ID of the created LU.

deleteLU operation deletes an existing LU by specifying its LU ID. Recovery operation is createLU which specifies LU ID of the deleted LU and ID of a disk drive in which the LU existed, start LBA of the LU in the disk drive, and size of the LU.

createLUN operation assigns specified LUN at specified port to a LU specified by LU ID. Recovery operation is deleteLUN which specifies the LUN at the port.

deleteLUN operation deletes an existing LUN at a port. Recovery operation is createLUN which specifies deleted LUN at the port and ID of a LU which is assigned the LUN.

addWNN operation adds one or more WNNs to specified LUN at specified port. Recovery operation is removeWNN which specifies the same arguments.

removeWNN operation removes one or more WNNs from specified LUN at specified port. Recovery operation is addWNN which specifies the same arguments.

### 3. Recording Events

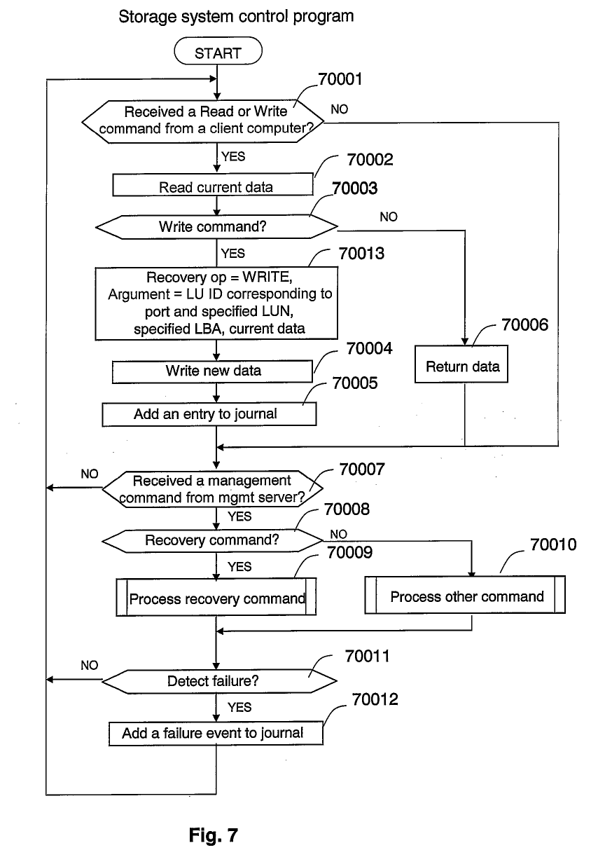

FIG. 7 illustrates the control flow of storage system control program operable to process READ and WRITE commands received from the client computers and also to process the management operations received from the management server. If the control program receives a command from a client computer (step 70001), it first reads data currently stored at LBA in LU specified by the command (step 70002). If the command is WRITE command (step 70003), the corresponding recovery operation to be stored in the journal is prepared (step 70013). After writing the new data (step 70004), the operation and the recovery operation is stored in the CDP journal together with the current time information (step 70005). Otherwise, the control program returns the data read in step 70002 to the client computer (step 70006).

If the control program receives a management command from the management server (step 70007), it proceeds to process the command (step 70008-70010). Processing details of recovery command (step 70009) as well as other commands (step 70010) are explained in detail below. If the control program detects a failure (step 70011), it records the failure information together with the current time in the CDP journal (step 70012).

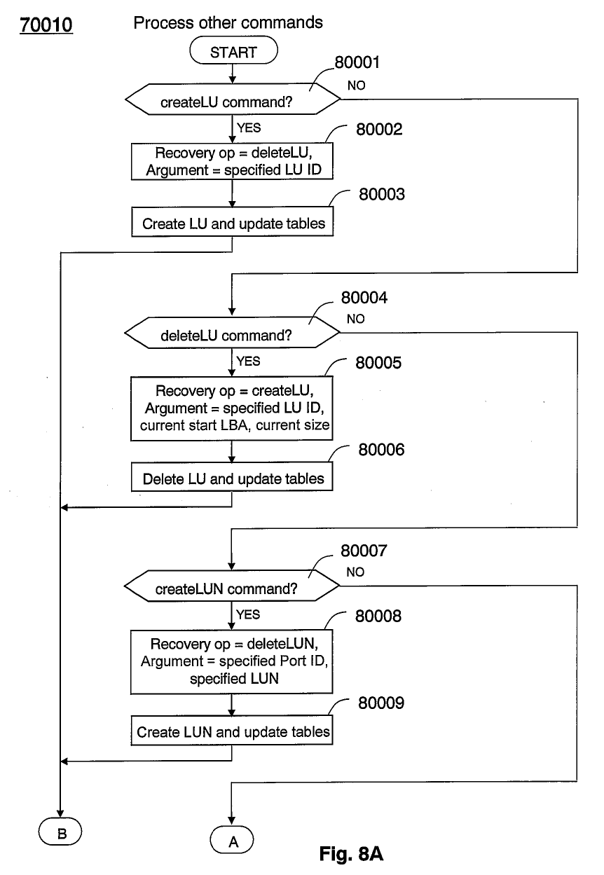

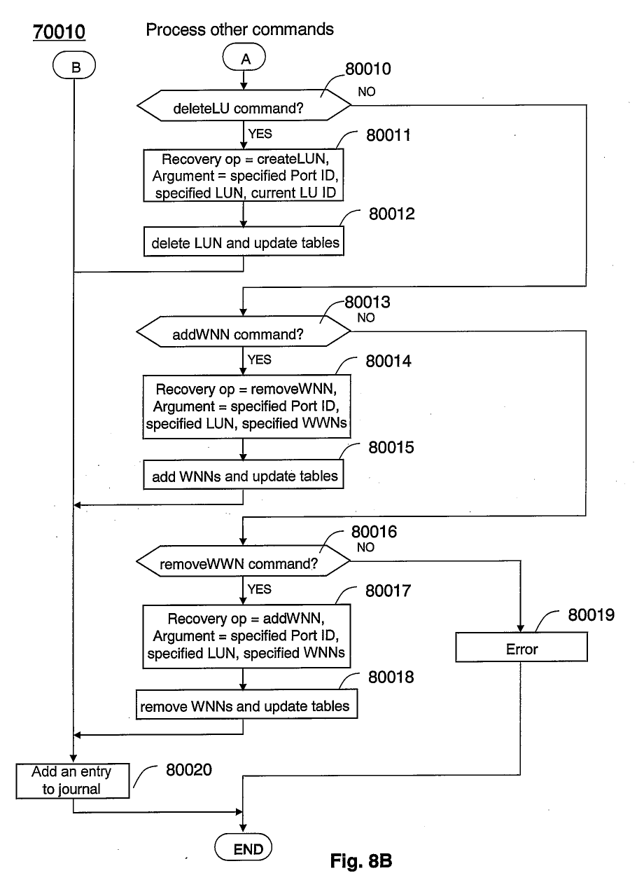

FIG. 8A and 8B show the process flow of the management commands other than the recovery commands. Specifically, if the storage system control program identifies an operation (step 80001, 80004, 80007, 80010, 80013, and 80016), it prepares a recovery operation corresponding to the identified operation (step 80002, 80005, 80008, 80011, 80014, and 80017), processes the operation and updates the relevant tables (step 80003, 80006, 80009, 80012, 80015, and 80018), and, finally, adds an entry to the CDP journal (step 80020).

### 4. Recovering Data and Configuration

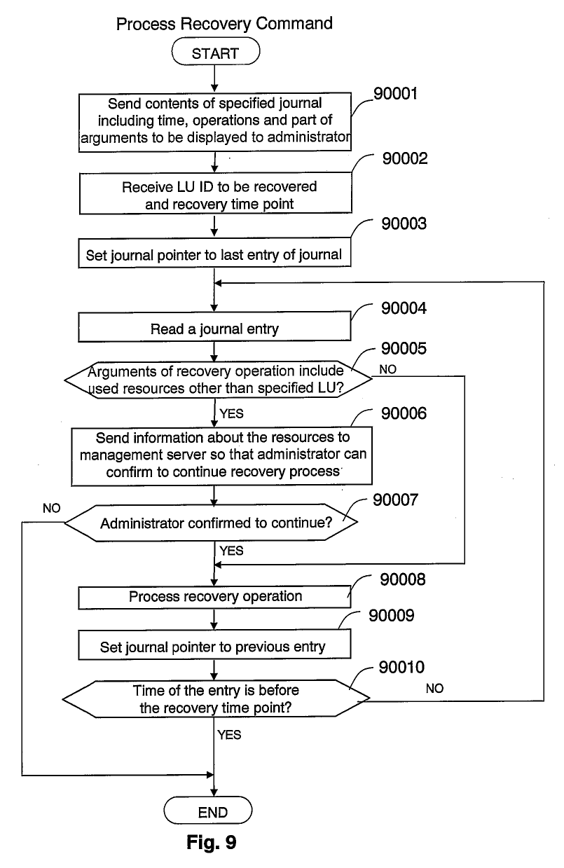

FIG. 9 illustrates the process flow of the inventive recovery procedure. Specifically, if the administrator initiates the recovery process, the storage system control program sends contents of the CDP journal to the management server to enable the management program to display a series of recorded events to the administrator (step 90001). After that, the administrator specifies the LU to be recovered and a recovery time point (step 90002). The storage system control program then begins to recover data and configuration by processing recovery operations stored in the CDP journal from the current time point to the specified recovery time point. (step 90003-90010).

First, the storage system control program reads the last, i.e., the newest entry in the CDP journal (step 90003 and 90004). If the recovery operation needs to change or delete resources other than the LU to be recovered (step 90005), the storage system control program sends the information about the affected resources to the management server and the management program displays the received information to the administrator. After viewing the displayed information, the administrator is provided with an opportunity to specify whether or not the recovery process should continue (step 90006). In this embodiment, the affected resources may include LUs other than the LU to be recovered, blocks in other LUs, LUNs assigned to other LUs, lists of WWNs, which assigned to other LUs. It should be noted that it is possible to determine whether the resources are currently used by looking up LU table and LUN table.

If the administrator decides to terminate the process, the process terminates at step 90007. Otherwise, the process processes the recovery operation recorded in the journal entry (step 90008) and prepares to process the next journal entry (step 90009). If the time of the next journal entry is determined to be prior to the recovery time point specified by the administrator (step 90010), the process terminates because both the configuration of the disk array system and the data in the specified LU at the specified time point have been reproduced.

### Second Embodiment

In this embodiment, the disk array system incorporates so-called thin provisioning functionality. Thin provisioning functionality provides a virtual LU (VLU) which the client computers recognize as a regular LU, but which does not have all of the associated storage blocks allocated within physical storage devices. Instead, the storage system control program assigns blocks to the virtual LU from a pre-defined block pool when the client computers attempt to write data into the blocks. Thus, the capacity used to initially create the aforesaid VLU is zero regardless of the size of the created VLU, unless and until the client computers write actual data to the created VLU. If the client computer attempts to read a data block from a VLU, which has not yet been assigned, the storage system returns zero-filled data string.

Generally, the number of blocks assigned to a VLU increases with passing of time. If the administrator attempts to recover data in a VLU at a specified past point in time by using a traditional CDP technology, the assignment of blocks does not change. Specifically, some blocks may still be assigned to the VLU, even though they do not contain the actual data. By using the inventive methodology, assignment of blocks at the recovery time point is also reproduced. In the description below, the differences of the second embodiment from the first embodiment will be explained in detail.

### 1. System Structure

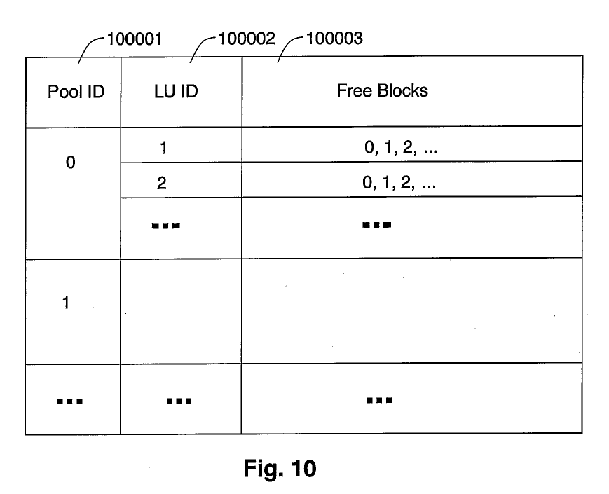

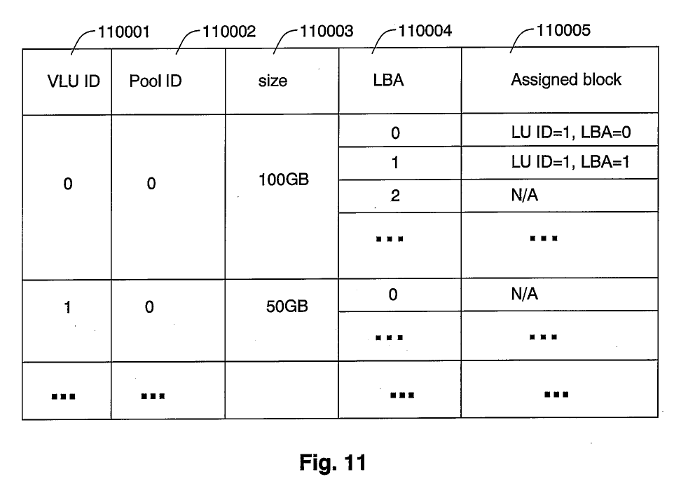

In FIG. 1, memory 10204 contains two additional tables: block pool table and VLU table. As shown in FIG. 10, for each pool, block pool table contains Pool ID 100001, a list of LUs which compose the pool 100002, and lists of free blocks in the LUs 100003. As shown in FIG. 11, for each VLU, VLU table contains VLU ID 110001, ID of block pool from which blocks are assigned to the VLU (110002), size of the VLU (110003), and mapping between LBA of VLU (110004) and assigned block which consists of LU ID in which the block exists and LBA in the LU (110005).

In this embodiment, LUs compose block pools and are not exposed to client computers directly. Instead, clients access VLUs. For this reason, all terms ‘LU’ in the description of the first embodiment should be replaced by ‘VLU’.

### 2. Operations and Recovery Operations

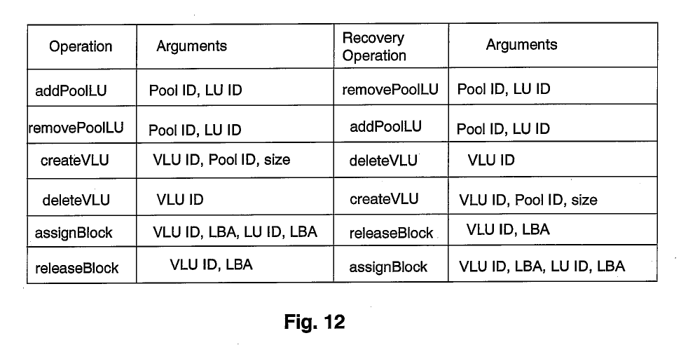

FIG. 12 shows a list of additional operations and corresponding recovery operations to be recorded in the CDP journal in this embodiment. assignBlock is internally processed when a client computer writes data and a block is assigned to a VLU. Other commands are issued by the management server. These operations update the tables by adding new entries, deleting existing entries, or modifying the contents of the tables based on arguments described below.

addPoolLU adds a LU specified by LU ID to a block pool specified by pool ID. Recovery operation corresponding to this operation is removePoolLU, which specifies the same arguments.

removePoolLU removes a LU specified by LU ID from a block pool specified by pool ID. Recovery operation is addPoolLU, which specifies the same arguments.

createVLU creates a VLU by specifying ID of VLU to be created, ID of a block pool from which blocks are assigned to the VLU, and size of the VLU. Recovery operation is deleteVLU which specifies ID of created VLU.

deleteVLU deletes a VLU specified by VLU ID. Recovery operation is createVLU which specifies ID of the deleted VLU and ID of a block pool assigned to the VLU, and size of the VLU.

assignBlock assigns a block to specified LBA in specified VLU. The block is picked from specified LBA in the LU. Recovery operation is releaseBlock which specifies ID of the VLU and LBA of the assigned block in the VLU.

releaseBlock releases a block from specified LBA in specified VLU. Recovery operation is assignBlock which specifies ID of the VLU, LBA of the released block in the VLU, ID of LU in which the released block existed, and LBA of the block in the LU.

### 3. Recording Events

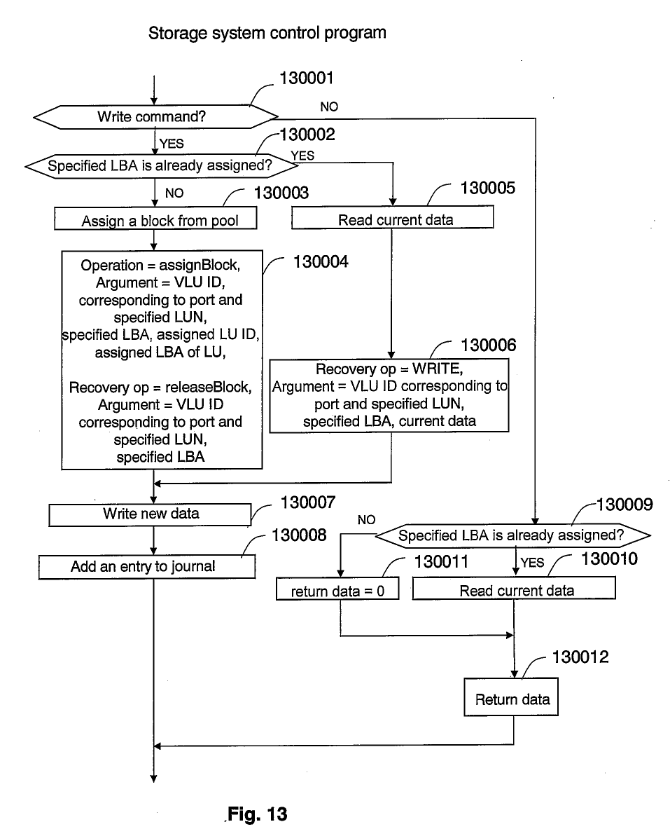

In this embodiment, steps 70002-70006 and 70013 in FIG. 7 are replaced by steps 130001-130012 in FIG. 13, which implement the thin provisioning.

In FIG. 13, if the command received is WRITE (step 130001) and LBA specified by the command has already been assigned a block (step 130002), the storage system control program reads the current data from the block (step 130005) and prepares recovery operation of this operation (step 130006) which is similar to step 70013 in FIG. 7. Otherwise, it assigns a free block from a block pool assigned to the VLU before write the data (step 130003) and prepares recovery operation of this operation (step 130004). In this case, operation to be recorded in journal is assignBlock, not WRITE. Next, storage system control program writes the data (step 130007) and add an entry to CDP journal (step 130008).

If the received command is READ and LBA specified by the command has already been assigned a block (step 130009), storage system control program reads the current data from the block (step 130010). Otherwise, prepare data to be returned which is filled by 0 (step 130011). Then, the data is returned to a client computer (step 130012).

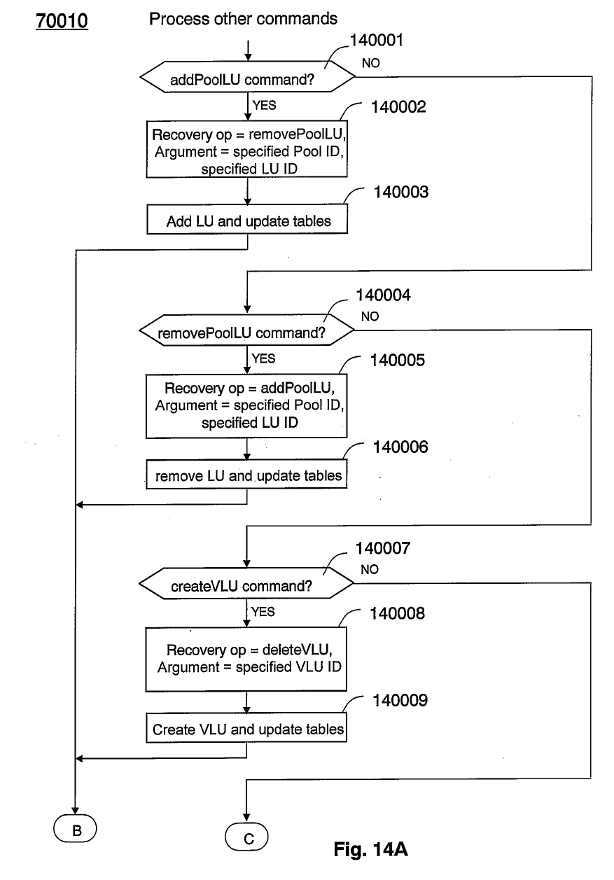

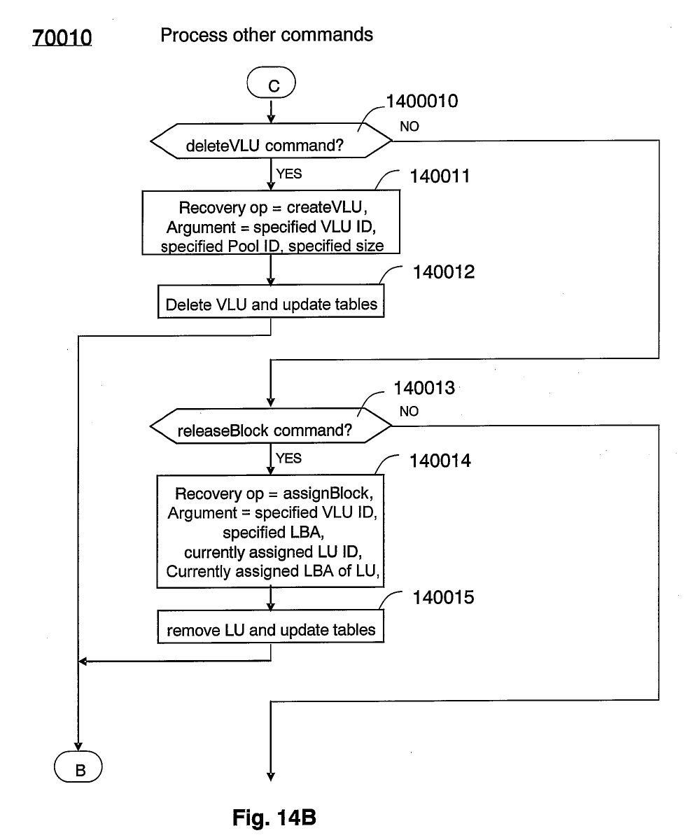

In terms of process flow of management commands other than recovery, steps 140001-140015 in FIG. 14A and 14B are inserted before step 80001 in FIG. 8A so that these steps record every configuration change and the corresponding recovery operation related to thin provisioning function into the CDP journal.

### 4. Recovering Data and Configuration

The process flow for recovery procedure is exactly the same as the corresponding process of the first embodiment as shown in FIG. 9. By process recovery operations related to thin provisioning function during the recovery process, the assignment of blocks in VLU at the recovery time point is also reproduced so that it is possible to avoid unnecessary assignment of blocks which do not contain data.

### [Description of Exemplary Computer Platform]

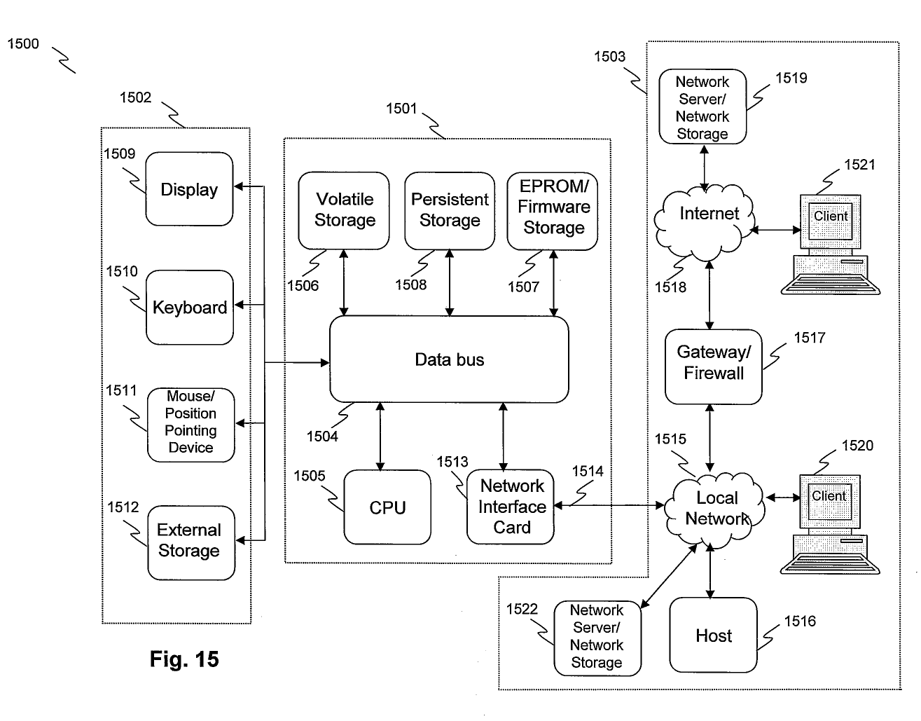

FIG. 15 is a block diagram that illustrates an embodiment of a computer/server system 1500 upon which an embodiment of the inventive methodology may be implemented. The system 1500 includes a computer/server platform 1501, peripheral devices 1502 and network resources 1503.

The computer platform 1501 may include a data bus 1504 or other communication mechanism for communicating information across and among various parts of the computer platform 1501, and a processor 1505 coupled with bus 1501 for processing information and performing other computational and control tasks. Computer platform 1501 also includes a volatile storage 1506, such as a random access memory (RAM) or other dynamic storage device, coupled to bus 1504 for storing various information as well as instructions to be executed by processor 1505. The volatile storage 1506 also may be used for storing temporary variables or other intermediate information during execution of instructions by processor 1505. Computer platform 1501 may further include a read only memory (ROM or EPROM) 1507 or other static storage device coupled to bus 1504 for storing static information and instructions for processor 1505, such as basic input-output system (BIOS), as well as various system configuration parameters. A persistent storage device 1508, such as a magnetic disk, optical disk, or solid-state flash memory device is provided and coupled to bus 1501 for storing information and instructions.

Computer platform 1501 may be coupled via bus 1504 to a display 1509, such as a cathode ray tube (CRT), plasma display, or a liquid crystal display (LCD), for displaying information to a system administrator or user of the computer platform 1501. An input device 1510, including alphanumeric and other keys, is coupled to bus 1501 for communicating information and command selections to processor 1505. Another type of user input device is cursor control device 1511, such as a mouse, a trackball, or cursor direction keys for communicating direction information and command selections to processor 1504 and for controlling cursor movement on display 1509. This input device typically has two degrees of freedom in two axes, a first axis (e.g., x) and a second axis (e.g., y), that allows the device to specify positions in a plane.

An external storage device 1512 may be connected to the computer platform 1501 via bus 1504 to provide an extra or removable storage capacity for the computer platform 1501. In an embodiment of the computer system 1500, the external removable storage device 1512 may be used to facilitate exchange of data with other computer systems.

The invention is related to the use of computer system 1500 for implementing the techniques described herein. In an embodiment, the inventive system may reside on a machine such as computer platform 1501. According to one embodiment of the invention, the techniques described herein are performed by computer system 1500 in response to processor 1505 executing one or more sequences of one or more instructions contained in the volatile memory 1506. Such instructions may be read into volatile memory 1506 from another computer-readable medium, such as persistent storage device 1508. Execution of the sequences of instructions contained in the volatile memory 1506 causes processor 1505 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1505 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1508. Volatile media includes dynamic memory, such as volatile storage 1506. Transmission media includes coaxial cables, copper wire and fiber optics, including the wires that comprise data bus 1504. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1505 for execution. For example, the instructions may initially be carried on a magnetic disk from a remote computer. Alternatively, a remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on the data bus 1504. The bus 1504 carries the data to the volatile storage 1506, from which processor 1505 retrieves and executes the instructions. The instructions received by the volatile memory 1506 may optionally be stored on persistent storage device 1508 either before or after execution by processor 1505. The instructions may also be downloaded into the computer platform 1501 via Internet using a variety of network data communication protocols well known in the art.

The computer platform 1501 also includes a communication interface, such as network interface card 1513 coupled to the data bus 1504. Communication interface 1513 provides a two-way data communication coupling to a network link 1514 that is connected to a local network 1515. For example, communication interface 1513 may be a Fibre Channel interface. Also, communication interface 1513 may be an integrated services digital network (ISDN) card or a modem to provide a data communication connection to a corresponding type of telephone line. As another example, communication interface 1513 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 1513 sends and receives electrical, electromagnetic or optical signals that carry digital data streams representing various types of information.

Network link 1514 typically provides data communication through one or more networks to other network resources. For example, network link 1514 may provide a connection through local network 1515 to a host computer 1516, or a network storage/server 1517. Additionally or alternatively, the network link 1514 may connect through gateway/firewall 1517 to the wide-area or global network 1518, such as an Internet. Thus, the computer platform 1501 can access network resources located anywhere on the Internet 1518, such as a remote network storage/server 1519. On the other hand, the computer platform 1501 may also be accessed by clients located anywhere on the local network 1515 and/or the Internet 1518. The network clients 1520 and 1521 may themselves be implemented based on the computer platform similar to the platform 1501.

Local network 1515 and the Internet 1518 both use electrical, electromagnetic or optical signals that carry digital data streams. The signals through the various networks and the signals on network link 1514 and through communication interface 1513, which carry the digital data to and from computer platform 1501, are exemplary forms of carrier waves transporting the information.

Computer platform 1501 can send messages and receive data, including program code, through the variety of network(s) including Internet 1518 and local network 1515, network link 1514 and communication interface 1513. In the Internet example, when the system 1501 acts as a network server, it might transmit a requested code or data for an application program running on client(s) 1520 and/or 1521 through Internet 1518, gateway/firewall 1517, local network 1515 and communication interface 1513. Similarly, it may receive code from other network resources.

The received code may be executed by processor 1505 as it is received, and/or stored in persistent or volatile storage devices 1508 and 1506, respectively, or other non-volatile storage for later execution. In this manner, computer system 1501 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with continuous data protection functionality. It is intended that the specification and examples be considered as exemplary only, with a true scope and spirit of the invention being indicated by the following claims.

What is claimed is:

1. A computerized data storage system comprising:
a. A storage module operable to store data;
b. A control module operable to modify the stored data according to a request from at least one client computer; and
c. A continuous data protection module operable to store information on modification to the stored data in a journal, wherein the continuous data protection module is further operable to store to the journal information on configuration changes associated with the computerized data storage system and time information associated with the configuration changes.

2. The computerized data storage system of claim 1, wherein the stored information on configuration changes comprises information on a recovery operation corresponding to each configuration change.

3. The computerized data storage system of claim 1, further comprising a user interface module operable to display to an administrator the stored information on configuration changes as a series of events.

4. The computerized data storage system of claim 3, wherein the user interface module is further operable to receive from the administrator a recovery point based on the displayed series of events and wherein the control module is further operable to restore the data stored in the storage module and a configuration of the computerized data storage system at the recovery point based on the information on configuration changes associated with the computerized data storage system stored in the journal.

5. The computerized data storage system of claim 4, wherein the configuration of the computerized data storage system at the recovery point is restored by undoing configuration changes between the current time point and the recovery point.

6. The computerized data storage system of claim 1, wherein the storage module comprises at least one virtual storage device and wherein the continuous data protection module is further operable to store to the journal information on storage blocks assigned to the at least one virtual storage device.

7. A computerized data storage system comprising:
a. A storage module operable to store data;
b. A controller module operable to modify the stored data according to a request from at least one client computer; and
c. A continuous data protection module operable to store information on modification to the stored data in a journal, wherein the continuous data protection module is further operable to store to the journal information on detected failures associated with the computerized data storage system and time information associated with the detected failures.

8. The computerized data storage system of claim 7, further comprising a user interface module operable to display to an administrator the stored information on detected failures associated with the computerized data storage system as a series of events.

9. The computerized data storage system of claim 8, wherein the user interface module is further operable to receive from the administrator a recovery point based on the displayed series of events.

10. A method to be performed by a computerized data storage system, the method comprising:
a. storing data in a storage device;
b. receiving a data modification request from a client computer;
c. modifying the stored data according to the received data modification request;
d. storing information on modification to the stored data in a journal; and
e. storing to the journal information on configuration changes associated with the computerized data storage system and time information associated with the configuration changes.

11. The method of claim 10, wherein the stored information on configuration changes comprises information on a recovery operation corresponding to each configuration change.

12. The method of claim 10, further comprising displaying to an administrator the stored information on configuration changes as a series of events.

13. The method of claim 12, further comprising receiving from the administrator a recovery point based on the displayed series of events and restoring the data stored in the storage device and a configuration of the computerized data storage system at the recovery point based on the information on configuration changes associated with the computerized data storage system stored in the journal.

14. The method of claim 13, wherein the configuration of the computerized data storage system at the recovery point is restored by undoing configuration changes between the current time point and the recovery point.

15. The method of claim 10, wherein the storage device comprises at least one virtual storage device and wherein the method further comprises storing to the journal information on storage blocks assigned to the at least one virtual storage device.

16. A method to be performed by a computerized data storage system, the method comprising:
a. storing data on a storage media;
b. receiving a data modification request from a client computer;
c. modifying the stored data according to the received data modification request;
d. storing information on modification to the stored data in a journal;
e. detecting failures associated with the computerized data storage system; and
f. storing to the journal information on the detected failures associated with the computerized data storage system and time information associated with the detected failures.

17. The method of claim 16, further comprising displaying to an administrator the stored information on detected failures associated with the computerized data storage system as a series of events.

18. The method of claim 17, further comprising receiving from the administrator a recovery point based on the displayed series of events.

19. A journal comprising:
a. information on modification to data stored in a computerized data storage system; and
b. information on configuration changes associated with the computerized data storage system and time information associated with the configuration changes.

20. The journal of claim 19, wherein the stored information on configuration changes comprises information on a recovery operation corresponding to each configuration change.

21. A journal comprising:
a. information on modification to data stored in a computerized data storage system; and
b. information on detected failures associated with the computerized data storage system and time information associated with the detected failures.
